(19) United States
(12) Patent Application Publication
(10) Pub. No.: US 2021/0182104 A1
(43) Pub. Date: Jun. 17, 2021

(54) EXECUTING COMPUTING MODULES USING MULTI-CORING

(71) Applicant: Capital One Services, LLC, McLean, VA (US)

(72) Inventors: Sravankumar KARANAM, Frisco, TX (US); Ryan M. PARKER, Dallas, TX (US); Manjula MARAKANI, McLean, VA (US)

(73) Assignee: Capital One Services, LLC, McLean, VA (US)

(21) Appl. No.: 17/170,496

(22) Filed: Feb. 8, 2021

Related U.S. Application Data
(63) Continuation-in-part of application No. 16/519,190, filed on Jul. 23, 2019, now Pat. No. 10,915,367.
Application No. 16/519,190 is a continuation-in-part of application No. 17/035,031, filed on Sep. 28, 2020.
Application No. 17/035,031 is a continuation of application No. 16/563,240, filed on Sep. 6, 2019, now Pat. No. 10,789,103.

(51) Int. Cl. G06F 9/50; G06F 16/903; G06F 9/54; H04L 29/08

(52) U.S. Cl. CPC G06F 9/505; H04L 67/34; G06F 9/546; G06F 16/90344

(57) ABSTRACT

Described herein is a system for executing a computing module. Described herein is a system for executing a computing module. The system may determine whether a function of a computing module is suitable to be executed using multi-coring. The system identifies one or more available computing cores and executes the function on the one or more available computing cores. The one or more available computing cores can be dedicated to execute the function until the execution of the function is complete. The one or more available computing cores execute the tasks of the function asynchronously. The system receives output data from the function asynchronously in a list data structure. The system can maintain a desired order of the output data in the list data structure.

### CROSS-REFERENCE TO RELATED APPLICATIONS

This application is a Continuation-in-Part of U.S. application Ser. No. 16/519,190, filed on Jul. 23, 2019; and this application is also a Continuation-in-Part of U.S. application Ser. No. 17/035,031, filed on Sep. 28, 2020, which is a Continuation of U.S. application Ser. No. 16/563,240, filed on Sep. 6, 2019 (now U.S. Pat. No. 10,789,103, and issued on Sep. 29, 2020). The contents of each of these applications are incorporated herein by reference in their entireties.

### BACKGROUND

Large entities such as financial institutions, retail stores, educational institutions, government agencies, and/or the like may electronically process large amounts of data and execute large amounts of calculations on a daily basis. Events such as natural disasters, updated regulations, power outages, and/or the like can cause a sudden influx in the data (e.g., customer complaints, questions, usage of a mobile application, and/or the like) that needs to be processed and the calculations needed to be executed. These entities may implement computing modules including multiple functions to process the large amounts of data and execute the large amounts of calculations. The functions include code or a set of instructions written in a programming language. The functions may execute a specified set of tasks. Each function may process data, execute calculations, and make function calls. Heavy computations that are not serializable and take large amounts of time can use large amounts of computational resources, and cause bottlenecks and network latency. Certain functions may take hours or days to complete due to millions of records and large amounts of calculations to be executed. Conventionally, entities would have to wait to execute computationally expensive functions when the usage of computer resources and the network is at a minimum. This can be inefficient as functions may need to be executed at any time of the day.

As an example, certain compliance applications implemented by large entities may electronically process large amounts of data and execute large amounts of calculations on a daily basis. Additionally, the compliance applications may include functions configured to perform a variety of tasks.

The large entities described above are required to comply with regulations, laws, and/or statutes implemented and enforced by government institutions. To ensure that these large entities comply with the regulations, laws, and/or statutes large entities have developed applications including executable code for verifying the large entities are complying with the regulations, laws, and/or statutes. Compliance application may verify an entity's compliance with financial regulations, cybersecurity laws, privacy laws, and/or the like. Compliance applications may verify an entity's compliance with compliance data such as with laws, regulations, and/or statutes of various regulatory agencies. The regulatory agencies may update or create new regulations at a rapid pace. Conventionally, users may have to manually browse external data sources to identify updated compliance data and then manually determine which controls of the compliance applications are affected by the updated compliance data. This can be a long and error-prone process, which can use large amounts of computational resources for long periods of time.

### BRIEF DESCRIPTION OF THE FIGURES

The accompanying drawings, which are incorporated herein and form part of the specification, illustrate the present disclosure and, together with the description, further serve to explain the principles of the disclosure and enable a person skilled in the relevant art to make and use the disclosure.

FIG. 1 is a block diagram of an example environment in which systems and/or methods for executing a computing module may be implemented according to an example embodiment.

FIG. 2 illustrates example computing cores according to an embodiment.

FIG. 3 illustrates example flow of compliance data according to an embodiment.

FIGS. 4A-4B illustrate example data structures according to an embodiment.

FIG. 5 is a flowchart illustrating a process for executing a computing module using multi-coring according to an embodiment.

FIG. 6 is a flowchart illustrating a process for verifying a computing module is suitable for multi-coring according to an embodiment.

FIG. 7 is a flowchart illustrating a process for verifying a computing module is suitable for multi-coring according to an embodiment.

FIG. 8 is a flowchart illustrating a process for identifying controls which do not align with updated compliance data according to an embodiment.

FIG. 9 is a block diagram of example components of device according to an embodiment.

The drawing in which an element first appears is typically indicated by the leftmost digit or digits in the corresponding reference number. In the drawings, like reference numbers may indicate identical or functionally similar elements.

### DETAILED DESCRIPTION

Described herein is a system for executing a computing module. The system may determine whether a function of a computing module is suitable to be executed using multi-coring. That is the system determines whether a function is suitable to be executed by one or more computing cores in a dedicated fashion. The system identifies one or more available computing cores and executes the function on the one or more available computing cores. The one or more available computing cores can be dedicated to execute the function until the execution of the function is complete. For purposes of saving time and efficiency, the one or more available computing cores executes the tasks of the function asynchronously. The system receives output data from the function asynchronously in a list data structure. It can be appreciated that the output data may also be received as an array, stack, queue, and/or the like, but the output data will be discussed as a list throughout for the purposes of example, and not limitation. The system can maintain a desired order of the output data in the list data structure. Once the function has executed, the system converts the list data structure into a data frame data structure by transposing the data from the list data structure into the data frame data structure in the desired order.

The system solves the technical problem of network bottlenecks and network latency by dedicating computing cores to execute specific functions. In this configuration, other computing cores are available to execute other functions. Additionally, the system can quickly execute the functions by asynchronously executing the tasks of the function while maintaining the desired order of the output of the function.

Furthermore, described herein is a system for identifying controls not aligned with updated compliance data. The system may scrub external data sources for updated compliance data. The system may detect and extract the updated compliance data from the external data sources. The system may identify and correlate controls of compliance applications currently using compliance data which has now been updated. The system determines whether a control exists to cover the updated compliance data. In the event a control does not exist for the updated compliance data, a requirement may be generated for generating a new control for the updated compliance data. In the event a control for the updated compliance data exists, the system may determine whether the control covers the updated compliance data. In the event the control data does not cover the updated compliance data, the system may generate a requirement for modifying the existing control to cover the updated compliance data. The requirements may be output into a database.

The system solves a technical problem of manually having to search external data sources one by one, extract compliance data from the external data sources and correlating the controls of the compliance application with the extracted compliance data, which can be time-consuming and error-prone. Conventionally, this would require numerous queries and computational resources utilized over a long time period. The system described herein solves these problems by automatically extracting updated compliance data in a single execution of a scraping application, and correlating the compliance application with the extracted compliance data.

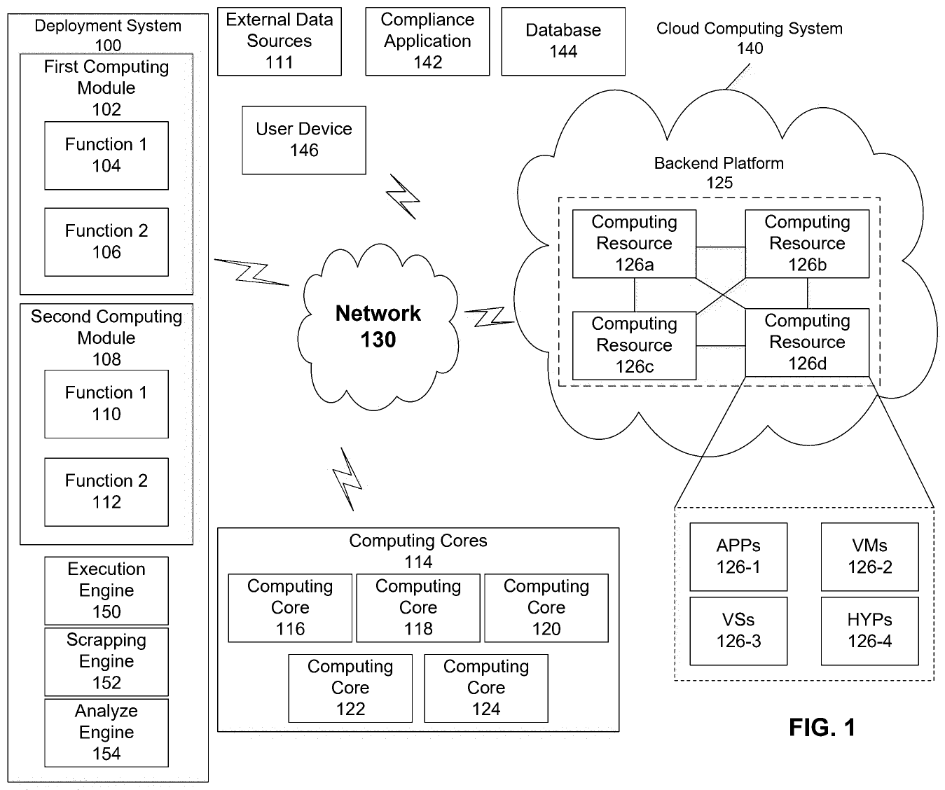

FIG. 1 is a block diagram of an example environment 100 in which systems and/or methods described herein may be implemented. The environment 100 may include a deployment system 100. The deployment system 100 may include a first computing module 102 and a second computing module 108. The first computing module 102 may include function 1 104 and function 2 106. The second computing module 108 may include function 1 110 and function 2 112. Environment 100 may further include computing cores 114. Computing cores 114 may be a pool of computing cores which includes several individual computing cores such as computing core 116, computing core 118, computing core 120, computing core 122, and computing core 124. The devices of the environment 300 may be connected through wired connections, wireless connections, or a combination of wired and wireless connections.

In an example embodiment, one or more portions of the network 130 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The backend platform 125 may include a server or a group of servers. In an embodiment, the backend platform 125 may be hosted in a cloud computing environment 140. It may be appreciated that the backend platform 125 may not be cloud-based, or may be partially cloud-based.

The cloud computing environment 140 includes an environment that delivers computing as a service, whereby shared resources, services, etc.. The cloud computing environment 140 may provide computation, software, data access, storage, and/or other services that do not require end-user knowledge of a physical location and configuration of a system and/or a device that delivers the services. The cloud computing system 140 may include computer resources 126a-d.

Each computing resource 126a-d includes one or more personal computers, workstations, computers, server devices, or other types of computation and/or communication devices. The computing resource(s) 126a-d may host the backend platform 125. The cloud resources may include compute instances executing in the cloud computing resources 126a-d. The cloud computing resources 126a-d may communicate with other cloud computing resources 126a-d via wired connections, wireless connections, or a combination of wired or wireless connections.

Computing resources 126a-d may include a group of cloud resources, such as one or more applications (“APPs”) 126-1, one or more virtual machines (“VMs”) 126-2, virtualized storage (“VS”) 126-3, and one or more hypervisors (“HYPs”) 126-4.

Application 125-1 may include one or more software applications that may be provided to or accessed by the user device 140. In an embodiment, the application 204 may execute locally on the user device 140. Alternatively, the application 126-1 may eliminate a need to install and execute software applications on the user device 140. The application 126-1 may include software associated with backend platform 125 and/or any other software configured to be provided across the cloud computing environment 140. The application 126-1 may send/receive information from one or more other applications 126-1, via the virtual machine 126-2.

Virtual machine 126-2 may include a software implementation of a machine (e.g., a computer) that executes programs like a physical machine. Virtual machine 126-2 may be either a system virtual machine or a process virtual machine, depending upon the use and degree of correspondence to any real machine by virtual machine 126-2. A system virtual machine may provide a complete system platform that supports execution of a complete operating system (OS). A process virtual machine may execute a single program and may support a single process. The virtual machine 126-2 may execute on behalf of a user (e.g., user device 140) and/or on behalf of one or more other backend platforms 125, and may manage infrastructure of cloud computing environment 140, such as data management, synchronization, or long duration data transfers.

Virtualized storage 126-3 may include one or more storage systems and/or one or more devices that use virtualization techniques within the storage systems or devices of computing resources 126a-d. With respect to a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how administrators manage storage for end users. File virtualization may eliminate dependencies between data accessed at a file level and location where files are physically store. This may enable optimization of storage use, server consolidation, and/or performance of non-disruptive file migrations.

Hypervisor 126-4 may provide hardware virtualization techniques that allow multiple operations systems (e.g., “guest operating systems”) to execute concurrently on a host computer, such as computing resources 126a-d. Hypervisor 126-4 may present a virtual operating platform to the guest operating systems, and may manage the execution of the guest operating systems multiple instances of a variety of operating systems and may share virtualized hardware resource.

In an embodiment, first computing module 102 includes function 1 104 and function 2 106. Second computing module 108 includes function 1 110 and function 2 112. Function 1104, function 2 106, function 1 110, and function 2 112, may be code programmed in a programming language such as Python, Java, C++, C, C #, and/or the like. The code may be instructions to complete a set of tasks. Function 1104, function 2 106, function 1 110, and function 2 112 may process data, execute calculations and return data when executed. Each of the first and second computing module 102, 108 may be programmed to execute various tasks. Function 1 104 and function 2 106 may execute the tasks to be completed by first computing module 102. Function 1 110, and function 2 112 may execute the various tasks to be executed by second computing module 108.

As a non-limiting example, first computing module 102 may be programmed to detect words or phrases from audio, video, and/or text files. Second computing module 108 may be programmed to generate reports based on the detected words or phrases from the audio, video, and/or text files. Accordingly, function 1 104 and function 2 106 of first computing system 102 may individually or together execute the tasks necessary for detecting words or phrases from audio, video, and/or text files. Function 1 110 and function 2 112 of the second computing module 108 may individually or together execute the tasks necessary to generate a report based on the detected words or phrases from the audio, video, and/or text files. Each function may require different arguments.

Continuing with the earlier example, function 2 106 may be responsible for generating or retrieving the audio, video, and/or text files. Function 2 106 may call function 1 104 and provide the audio, video, and/or text files as arguments. Function 1 104 may be responsible for detecting the words or phrases from the audio, video, and/or text files received as arguments from function 2 106.

Computing cores 114 may be a pool of computing cores 116-124. Computing cores 116-124 may be separate processing units configured to execute functions of the first and second computing modules 102, 108. Computing cores 116-124 may execute on one or more processors. Computing cores 116-124 may execute independently or in combination with one another. Computing cores 114 may be part of the cloud computing system 140. Alternatively, computing cores 114 may be separate from the cloud computing system 140.

Deployment system 100 may be configured to determine whether a function of the first and second computing modules 102, 108 is suitable executing using multi-coring or multiprocessing. Multi-coring is the concept using dedicated cores to execute a single function. For the purposes of speed and efficiency, multi-coring may be executed asynchronously. In this regard, using multi-coring, the tasks of a function may be executed in an asynchronous order. Multiprocessing includes the running of two or more programs or sequences of instructions simultaneously by a computer with more than one central processor. Using multiprocessing, deployment system 100 may execute the functions of the first and second computing modules 102, 108 using any one of the computing cores 116-124. In multi-coring one or more cores may be dedicated to only execute a single function. In multiprocessing any one of the computing cores may execute multiple functions in parallel or serially.

Deployment system 100 may determine whether a function is suitable for multi-coring or multiprocessing based on a series of steps. Initially, deployment system 100 may determine whether the code included in the function to be executed is computationally expensive. Deployment system 100 may determine the code is computationally expensive to execute based on an expected amount data to be processed by the code multiplied by an expected amount of calculations to be executed by the code. In response to determining the expected amount data to be processed by the code multiplied by the expected amount of calculations to be executed by the code is more than a threshold amount, the deployment system 100 may determine the code is computationally expensive. In response to determining code is not computationally expensive, deployment system may determine if the function is not suitable for multi-coring, as it may not be desirable to dedicate a set of resources to a function that is not computationally expensive to execute.

Next, deployment system 100 may determine whether the code of the function includes calculations that are interdependent of each other. As described above, using multi-coring, the tasks of a function may be executed asynchronously. Accordingly, in the event a function includes calculations which are dependent on other calculations, multi-coring may not be suitable for this function as the calculations may be executed out of the desired order. Likewise, deployment system 100 also determines whether the function has interdependences with other functions within the computing module. Multi-coring may not be suitable for a function in situations where the function is relying on other function calls, as the tasks of the function are executed asynchronously.

Next, deployment system 100 determines whether a computing module (i.e., first and second computing module 102, 108) has more than one function which is computationally expensive. Multi-coring may not be suitable for computing modules in which more than one function is computationally expensive as it may not be desirable to dedicate a large amount of computing cores to execute each computationally expensive function.

In the event deployment system 100 determines the code of the function is computationally expensive, does not include interdependent calculations, does not have interdependencies with other functions, and the computing module does not include more than one computationally expensive function, the deployment system 100 may determine the function may be suitable for multi-coring. Otherwise the deployment system 100 may determine the function is not suitable for multi-coring but rather is suitable for multiprocessing.

In the event a function is suitable for multi-coring, execution engine 150 may determine an amount of available computing cores. Execution engine 150 may determine the amount of computing cores necessary to execute the function. Execution engine 150 may assign the amount of computing cores from the available computing cores to execute the function. The assigned computing cores may execute the function and may not execute any other function until the function has completely executed. Execution engine 150 may execute the function on the assigned computing cores. In a non-limiting example, multi-coring may be implemented using Python which may include a global interpreter lock. The global interpreter lock is a mutex or a lock that allows only one computing core to be dedicated to execute the function.

As the assigned computing cores execute the function asynchronously, the function may return data asynchronously. Execution engine 150 may receive the data from the function and store the data in a list data structure rather than a data frame data structure. In this regard, execution engine 150 can ensure a desired order of the data is maintained even though the data may be received out of order. As an example, in the event a function is configured to execute task 1, task 2, and task 3. The assigned computing cores may execute the tasks in the following order: task 2, task 3, and task 1, leading to return data from each of these tasks out of order. It may be desirable to maintain the order of returned data from task 1, task 2, and task 3. Accordingly, execution engine 150 may maintain the order of the returned data in the list data structure as follows: [returned value from task 1, returned value from task 2, and returned value from task 3]. Execution engine 150 may transpose the list data structure into a data frame data structure, once the function has completely executed.

Once the assigned computing cores have completed the execution of the function using multi-coring, the assigned computing cores may be deemed available for selection again.

In the event deployment system 100 determines a function is suitable for multiprocessing, the execution engine may assign the function to a process and execute the process. The process may be executed by any one of the available computing cores.

In some embodiments, the deployment system 100 may include a scraping engine 152 and an analyzing engine 104. The example environment may further include external data sources 111, a compliance application 142, a database 144, and a user device 146. Compliance application 142 may be an executable application which verifies an entity's compliance with specified laws, regulations, and/or statutes. Different compliance applications 142 may verify entity's compliance with different types of laws, regulations, and/or statutes. For example, one compliance application 142 may verify an entity's compliance with financial laws, regulations, and/or statutes of a geographic region, while another compliance application 142 may verify an entity's compliance a cybersecurity laws, regulations, and/or statutes of a geographic region. Alternatively, a single compliance application 142 may verify an entity's compliance of all relevant laws, regulations, and/or statutes of a geographic region. The entity may be a financial institution, social media company, retail store, ecommerce website, government institution, educational institution, and/or the like.

Compliance application 142 includes controls which control the operation of compliance application 142 based on the current compliance data. Compliance data may be relevant laws and/or statutes. As an example, a given law may require two-step authentication for logging onto an entity's mobile application. Compliance application 142 may include a control to interrogate the entity's mobile application source code to confirm the entity's mobile application requires two-step authentication for logging onto the mobile application. In the event the mobile application does not require two-step authentication, the control of compliance application 142 may generate an error or alert.

To effectively and accurately execute compliance application 142, it is necessary to provide the most current compliance data to the compliance application 142, so that the controls can confirm the correct information. In this regard, deployment system 100 may execute scraping engine 152 to scrub external data sources 111 for updated compliance data. External data sources 111 may include databases, data repositories, websites, web services, RSS feeds, and/or the like. Scraping engine 152 may be a SCRAPY application developed in Python. The SCRAPY application is a web-crawler frame work that is configured to extract data from websites. Scraping engine 152 may extract data using Application Program Interfaces (APIs) or can be configured to be a general web-crawler.

Scraping engine 152 may include a set of instructions to search for and extract compliance data from various websites. Scraping engine 152 may include instructions to search for alphanumeric strings such as “new law”, “update in regulation”, “new legislation”, and/or the like. Scraping engine 152 may include instructions to extract any alphanumeric text relevant to updated compliance data. As an example, scraping engine 152 determines a date and time a “new law”, “update in regulation”, or “new legislation” has been posted on a website. If the new date and time within a specified time period (e.g., within the last week; last month; or last 6 months), then scraping engine 152 extracts the “new law”, “update in regulation”, or “new legislation” from the website.

Scraping engine 152 may return the updated compliance data to analyze engine 154. The updated compliance data may include multiple different updated laws, regulations, and/or statutes, and their relevant regulation ID. The regulation ID may be an identification number of the law, regulation, and/or statute. For example, the regulation ID may be a statute number, U.S. Title and Section number, and/or the like.

Analyze engine 154 may query database 144 to retrieve the current compliance data stored in the database 144. Analyze engine 154 may compare the current compliance data to the updated compliance data to determine the difference between the current compliance data and the updated compliance data. Analyze engine 154 may query database 144 to retrieve any controls relevant to the updated compliance data. Analyze engine 154 may correlate all of the controls to relevant to the updated compliance data. As described above, scraping engine 152 may return multiple different updated laws, regulations, and/or statutes and their relevant regulation ID. Analyze engine 154 may correlate the relevant control with each updated compliance data by matching a regulation ID of compliance data currently used by compliance application 142 with the regulation ID of the updated compliance data.

Analyze engine 154 may determine whether a control exists for the updated compliance data. In the event a control does not exist for the updated compliance data, analyze engine may generate a requirement for generating a new control for the updated compliance data. For example, the updated compliance data may be a new law, regulation, and/or statute. In the event a control for the updated compliance data exists, the analyze engine 154 may determine whether the control covers the updated compliance data. In the event the control data does not cover the updated compliance data, analyze engine 154 may generate a requirement for modifying the existing control to cover the updated compliance data. Analyze engine 154 may return the generated requirements. Deployment system 100 may output requirements to user device 146. Deployment system 100 may store the requirements in the database 144.

As a non-limiting example, scraping engine 152 may detect an updated code of advertising with the better business bureau (BBB). As an example input, the updated code on the (BBB) website may read, “2.1 Advertisers may offer a price reduction or savings by comparing their selling price with: 2.1.1 Their own former selling price”. Scraping engine 152 may extract the updated code from the BBB website and return the text of the updated code.

Analyze engine 154 may retrieve controls relevant to the updated code. The controls relevant to the updated code may be controls verifying the compliance of pricing and advertising. Analyze engine 154 may correlate the relevant controls with the updated code. Analyze engine 154 may correlate controls with the updated code by comparing the regulation ID of the updated code (i.e., 2.1 and 2.11) with the regulation ID of the compliance data currently used by the control.

Analyze engine 154 may determine whether a control exists to cover the updated code. In the event a control does not exist, analyze engine 154 may generate a requirement. Analyze engine 154 may determine whether a control exists for the updated compliance data. In the event a new control is needed for the updated compliance data, analyze engine 154 may generate a requirement for generating a new control for the updated compliance data. For example, the updated compliance data may be a new law, regulation, and/or statute. In the event a control for the updated compliance data exists, the analyze engine 154 may determine whether the control covers the updated compliance data. In the event the control data does not cover the updated compliance data, analyze engine 154 may generate a requirement for modifying the existing control to cover the updated compliance data.

Deployment system 100 may be configured to determine whether scraping engine 152 and/or analyze engine 154 are suitable for executing using multi-coring or multiprocessing. Multi-coring is the concept using dedicated cores to execute a single function. For the purposes of speed and efficiency, multi-coring may be executed asynchronously. In this regard, using multi-coring, the tasks of a function may be executed in an asynchronous order. Multiprocessing the running of two or more programs or sequences of instructions simultaneously by a computer with more than one central processor. Using multiprocessing deployment system 100 may execute the functions using anyone of the computing cores 116-124. In multi-coring one or more cores may be dedicated to only execute a single function. In multiprocessing any one of the computing cores may execute multiple functions in parallel or serially. Computing cores 114 may be a pool of computing cores 116-124. Computing cores 116-124 may be separate processing units configured to execute any function. Computing cores 116-124 may execute on one or more processors. Computing cores 116-124 independently or in combination with one another. Computing cores 114 may be part of the cloud computing system 140. Alternatively, computing cores 114 may be separate from the cloud computing system 140.

Deployment system 100 may determine whether a function is suitable for multi-coring or multiprocessing based on a series of steps. Initially, deployment system 100 may determine whether the code included in the function to be executed is computationally expensive. Deployment system 100 may determine the code is computationally expensive to execute based on an expected amount data to be processed by the code multiplied by an expected amount of calculations to be executed by the code. In response to determining the expected amount data to be processed by the code multiplied by the expected amount of calculations to be executed by the code is more than a threshold amount, the deployment system 100 may determine the code is computationally expensive. In response to determining code is not computationally expensive, deployment system may determine is the function is not suitable for multi-coring, as it may not be desirable to dedicate a set of resources to a function that is not computationally expensive to execute.

Next, deployment system 100 may determine whether the code of the function include calculations that are interdependent of each other. As described above, using multi-coring, the tasks of a function may be executed asynchronously. Accordingly, in the event a function includes calculations which are dependent on other calculations, multi-coring may not be suitable for this function as the calculations may be executed out of the desired order. Likewise, deployment system 100 also determines whether the function has interdependences with other functions. Multi-coring may not be suitable for a function in situations where the function is relying on other function calls, as the tasks of the function are executed asynchronously.

Next, deployment system 100 determines whether more than one function is computationally expensive. Multi-coring may not be suitable for when more than one function is computationally expensive as it may not be desirable to dedicate a large amount of computing cores to execute each computationally expensive function.

In the event deployment system 100 determines the code of the function is computationally expensive, does not include interdependent calculations, does not have interdependencies with other functions, and the more than one function are not computationally expensive, the deployment system 100 may determine the function may be suitable for multi-coring. Otherwise the deployment system 100 may determine the function is not suitable for multi-coring but rather is suitable for multiprocessing.

In the event a function is suitable for multi-coring, execution engine 150 may determine an amount of available computing cores. Execution engine 150 may determine the amount of computing cores necessary to execute the function. Execution engine 150 may assign the amount of computing cores from the available computing cores to execute the function. The assigned computing cores may execute the function and may not execute any other function until the function has completely executed. Execution engine 150 may execute the function on the assigned computing cores.

As the assigned computing cores execute the function asynchronously, the function may return data asynchronously. Execution engine 150 may receive the data from the function and store the data in a list data structure rather than a data frame data structure. In this regard, execution engine 150 can ensure a desired order of the data is maintained even though the data may be received out of order. As an example, in the event a function is configured to execute task 1, task 2, and task 3. The assigned computing cores may execute the tasks in the following order: task 2, task 3, and task 1, leading to return data from each of these tasks out of order. It may be desirable to maintain the order of returned data from task 1, task 2, and task 3. Accordingly, execution engine 150 may maintain the order of the returned data in the list data structure as follows: [returned value from task 1, returned value from task 2, and returned value from task 3]. Execution engine 150 may transpose the list data structure into a data frame data structure, once the function has completely executed.

Once the assigned computing cores have completed the execution of the function using multi-coring, the assigned computing cores may be deemed available for selection again.

In the event deployment system 100 determines a function is suitable for multiprocessing, the execution engine may assign the function to a process and execute the process. The process may be executed by any one of the available computing cores. Deployment system 100 may execute multiple functions at once using multiprocessing. The functions may be assigned to processes and executed. The processes may be structured as follows P1=Process(target=function 1, args( )); P2=Process(target=function 2, args( )); P3=Process(target=function 3, args( )). The args ( ) represent arguments required by each of the functions. The processes may be executed in parallel using any one of the available computing cores other than the computing cores dedicated to execute a function using multi-coring. The processes may be executed in parallel.

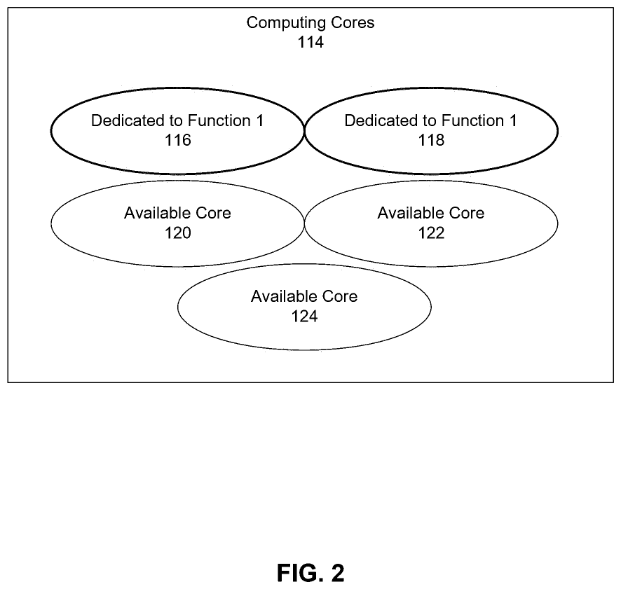

With reference to FIG. 2, example computing cores according to an embodiment are illustrated. FIG. 1 and FIG. 2 will be described concurrently. As described above, computing cores 114 is a pool of computing cores 116-124. Each of the computing cores 116-124 may be configured to either execute multiple functions or may be instructed to be dedicated to execute a single function.

As a non-limiting example, deployment system 100 may be implemented in a financial institution or retail environment. First computing module 102 may be configured to detect customer complaints received via email, telephone, short messaging service (SMS), websites, web based applications, and/or the like. In the event of a natural disaster or power outage customer complaints may sharply increase and the influx of data to be processed may also increase.

Function 1 104 of the first computing module 102 may be tasked to detect and collect specified words or phrases in the customer complaints which may increase drastically based on the influx in incoming data. Function 1 104 may return the detected specified words or phrases in a data frame data structure. Due to the influx of incoming data, deployment system 100 may determine whether Function 1 104 is suitable for using multi-coring.

Deployment system 100 may determine that due to the influx of large amounts of data to be processed by function 1 104, the amount of data to be processed multiplied by the calculations to be performed by function 104 will be greater than a threshold amount making it computationally expensive. Deployment system 100 may determine the calculations executed by function 1 104 are not interdependent on each other and function 1 104 is not interdependent of other functions in the first or second computing modules 102, 108. Deployment system 100 may also determine that function 2 106 of the first computing module is not computationally expensive to execute based on an expected amount of data to be processed multiplied an expected number of calculations to be executed. Accordingly, deployment system 100 may determine function 1 104 is suitable for multi-coring.

Deployment system 100 may determine computing cores 116-124 are available. Deployment system 100 may determine that two computing cores are necessary to execute function 1 104. Execution engine 150 may assign computing core 116 and 118 to execute function 1 104, as described above. As a non-limiting example, when executing multi-coring in Python, a collect_df function can be programmed using a df.values.tolist( ) function so that function 1 104 does not directly return a data frame data structure rather the values returned from function 1 104 are collected in a list data structure. The df.values.tolist( ) function converts a data frame data structure into a list data structure. In this regard, the collect_df function receives the output data as the data frame data structure function 1 104 is configured to output and converts the data frame data structure into a list data structure.

Execution engine 150 may execute the function on computing cores 116 and 118 by instructing the assigned computing cores 116 and 118 to execute function 1 104 using the arguments required to execute function 1 104. Additionally, execution engine 150 may call a function (i.e., collect_df) to receive the output data of function 1 104 as a list data structure. As an example, while executing multi-coring using Python, execution engine 150 can execute function on computing cores 116 and 118 by executing the following call: pool.apply_async(funct1, args=(x,y,z), callback=collect_df). Pool represents the assigned computing cores 116-118 dedicated to execute function 1 104. Apply_async instructs computing cores 116-118 to execute the tasks of function 1 104 asynchronously. Funct1 may represent function 1 104. Args=(x,y,z) represent the arguments required to execute function 1 104. Callback represents a list data structure configured to receive data from function 1 104 using the collect_df function.

Execution engine 150 may collect the data frame data structure returned by function 1 104 in a list data structure using the collect_df function. Execution engine 150 may convert the callback list data structure into a data frame data structure at the completion of the execution of function 1 104 by transposing the data in the callback list data structure into a data frame data structure. Once the execution of function 1 104 is completed, computing cores 116-118 can be deemed available again and eligible for executing different functions.

Deployment system 100 may determine function 2 106 of first computing module 102 and function 1 110 and function 2 112 of second computing module 108 may be executed using multi-processing. Accordingly, execution engine 150 may assign each of the function 1 106 and function 1 and 2 110, 112 to a process. The processes may be structured as follows P1=Process(target=function 2 106, args( )); P2=Process(target=function 1 110, args( )); P3=Process(target=function 2 112, args( )). The args ( ) represent arguments required by each of the functions. The processes may be executed in parallel using any one of the available computing cores 120-124 other than the computing cores 116-118 dedicated to execute function 1 104. Each of the processes may be initiated in parallel.

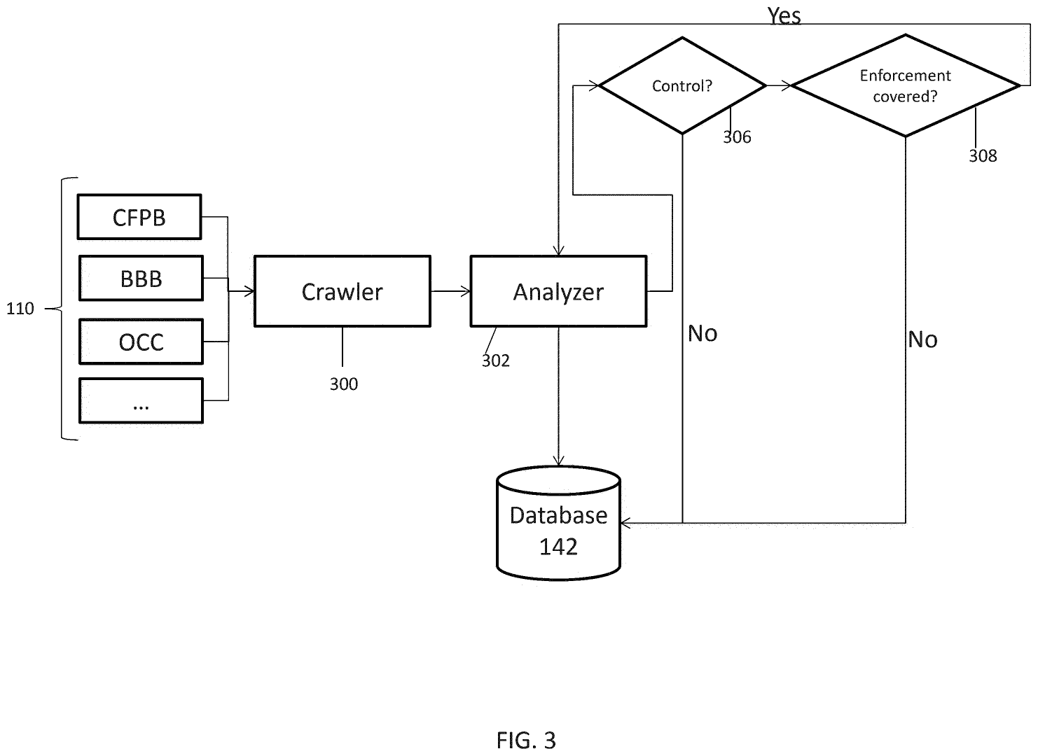

FIG. 3 illustrates example flow of compliance data according to an embodiment. A crawler 300 such as a scraping engine (e.g., scraping engine 152 as shown in FIG. 1) may detect and extract updated compliance data from external data sources 111. External data sources may include web sites of the Consumer Financial Protection Bureau (CFPB), Better Business Bureau (BBB), Office of the Comptroller of the Currency (OCC), and/or the like.

An analyzer 302 such as an analyze engine (e.g., analyze engine 154 as shown in FIG. 1) may query database 142 to retrieve controls and compliance data currently used by the controls. Analyzer 302 may correlate the relevant controls with the updated compliance data using the regulation ID of the updated compliance data and the compliance data currently used by the controls.

In operation 304 analyzer 302 may determine whether a control exists to cover the updated compliance data. In the event a control does not exist, the analyzer 302 may generate a new requirement for generating a new control to cover the updated compliance data and store the new requirement in the database 142. In the event a control does exist, in operation 306, analyzer 302 may determine whether the control covers the updated compliance data. In the event the control does not cover the updated compliance data, analyzer 302 may generate a requirement for modifying the existing control and may store the requirement in database 142.

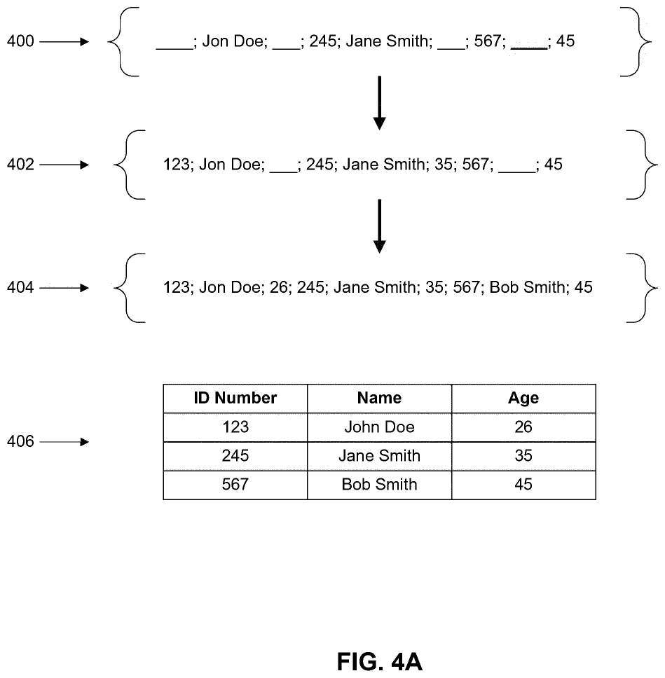

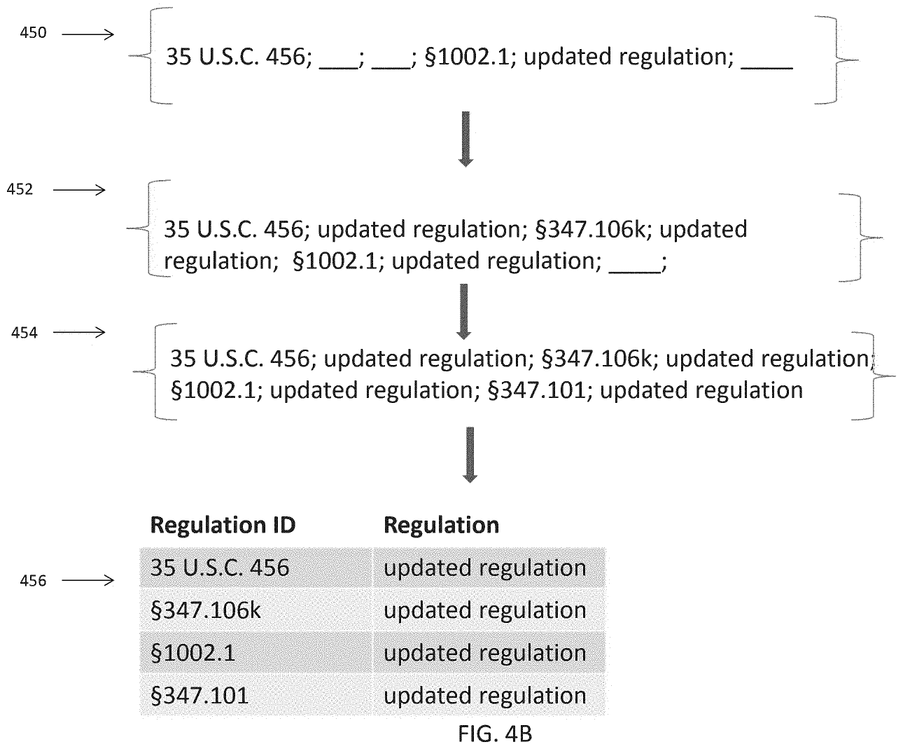

FIG. 4A illustrates example data structures according to an embodiment. As described above, while executing a function using multi-coring, the function completes the tasks asynchronously. In this regard, the function returns and/or outputs data asynchronously. The function may return and/or output values in a data frame data structure. A data frame data structure is a two dimensional data structure, where data is aligned in a tabular fashion in rows and columns. The data may be associated to a key value pair. The execution engine (e.g., execution engine 150 as shown in FIG. 1) may receive and store the data from the function in a list data structure. A list data structure is a one dimensional changeable ordered sequence of elements. As the execution engine may receive the data asynchronously, the execution engine maintains a desired order so that the data in the list data structure can be accurately transposed to a data frame data structure.

As a non-limiting example, the deployment system (e.g., deployment system 100 as shown in FIG. 1) may deploy a function using multi-coring which preforms the tasks of retrieving account holder IDs, names, and ages. Each respective account holder ID, name, and age can be tied to a single account. As the function is executed, the execution engine starts receiving output data from the function as the function completes the respective tasks asynchronously. The execution engine stores the output data in a list data structure 300. List data structure 300 may include the account holder name of “Jon Doe.” However, it may be missing the respective account holder ID number and age. List data structure 300 may further include account holder ID number of “245” and account holder name of “Jane Smith”, however, the data structure may be missing the age of “Jane Smith”. List data structure 300 may further include account holder ID number of 567 and account holder age of 45, however, it may be missing the account holder name for account holder ID number of 567. As shown by list data structure 300, the execution engine may store the data in a particular order such that the account holder ID, name, and age that are tied to the same account are adjacent to one another. However, it can be appreciated that the execution engine may store the data in any specified order such that the data from the list data structure may be transposed to a data frame data structure.

List data structure 402 may store more data as the function completes more tasks. The execution engine may receive the account holder ID number for “Jon Doe” and the age for “Jane Smith”. Accordingly, list data structure 402 may store the account holder ID number for “Jon Doe” and the age for “Jane Smith” in their designated positions in list data structure 402.

As the function completes its final tasks, the execution engine may receive the age for “Jon Doe” and the name for account holder ID “567”. Accordingly, list data structure 404 may store the age for “Jon Doe” and the name for account holder “567” in their designated position in list data structure 404.

Once the function has completed all of its tasks, the execution engine may determine list data structure 404 is complete. The execution engine may then transpose the values of list data structure 404 into a data frame data structure 406. As a non-limiting example, data frame data structure 406 may be set up to include three rows and three columns. The first column may store account holder ID numbers, the second column can store account holder names, and the third column can store account holder ages. The account holder ID number may be the key value pair. The execution engine transposes the value in the order maintained by list data structure 304. For example, account holder ID number “123”, account holder name “Jon Doe”, and account holder age “26” are transposed into the first row; holder ID number “245”, account holder name “Jane Smith”, and account holder age “35” are transposed into the second row; and holder ID number “567”, account holder name “Bob Smith”, and account holder age “45” are transposed into the third row. Data frame data structure 406 may store the data in the desired order, such that information for each separate account is stored in a single row.

FIG. 4B illustrates example data structures according to an embodiment. As described above, while executing a function using multi-coring, the function completes the tasks asynchronously. A data frame data structure is a two-dimensional data structure, where data is aligned in a tabular fashion in rows and columns. The data may be associated to a key value pair. A list data structure is a one-dimensional changeable ordered sequence of elements. The function returns the data asynchronously to the function (i.e., collect_df) to receive the output data of scraping engine 152 as a list data structure. As the list data structure may receive the data asynchronously, the list data structure maintains a desired order so that the data in the list data structure can be accurately transposed to a data frame data structure.

As a non-limiting example, the deployment system (e.g., deployment system 100 as shown in FIG. 1) may deploy a function, such as the scraping engine, using multi-coring which preforms the task scraping external data sources for compliance data different than the compliance data currently used by compliance applications. The compliance data may include laws or regulations that determine compliance of an entity. The compliance data may be alphanumeric text. As the scraping engine is executed, the execution engine starts receiving output from the scraping engine as the function completes the respective tasks asynchronously. The output data can include an updated law or regulation and regulation ID identifying the law or regulation. The regulation ID can be a statute number, US Title and Section number, and/or the like. The regulation ID can be the key value pair. The execution engine stores the output data in a list data structure 450. List data structure 450 may include regulation ID “35 U.S.C. 456” and may be missing the updated regulation. List data structure 400 may further include regulation ID § 1200.1 and the updated regulation. As shown by list data structure 450, the execution engine may store the data in a particular order such that the regulation ID and the updated regulation are adjacent to one another. However, it can be appreciated that the execution engine may store the data in any specified order such that the data from the list data structure may be transposed to a data frame data structure.

List data structure 452 may store more data as the function completes more tasks. The execution engine may receive the updated regulation for regulation ID “35 U.S.C. 456”. Accordingly, list data structure 452 may store the updated regulation for code number “35 U.S.C. 456” in its designated positions in list data structure 452. The execution engine may also receive regulation ID “§ 347.106k” and the updated regulation. Accordingly, list data structure 452 may store regulation ID “§ 347.106k” and the updated regulation in its respective position in the list data structure 452.

As the function completes its final tasks, the execution engine may receive regulation ID “§ 347.101” and the updated regulation. Accordingly, list data structure 454 may store receive regulation ID “§ 347.101” and the updated regulation in their designated positions in list data structure 454.

Once the function has completed all of its tasks, the execution engine may determine list data structure 454 is complete. The execution engine may then transpose the values of list data structure 454 into a data frame data structure 456. As a non-limiting example, data frame data structure 456 may be set up to include two rows and four columns. The first column may store regulation ID numbers, the second column stores the alphanumeric text of the updated regulation. The regulation ID number may be the key value pair. The execution engine transposes the value in the order maintained by list data structure 454. For example, “35 U.S.C. 456” and the updated regulation are transposed into the first row; “§ 347.101” and the updated regulation are transposed into the second row; “§ 1200.1” and the updated regulation are transposed into the third row; “§ 347.101” and the updated regulation are transposed to the fourth row. Data frame data structure 456 may store the data in the desired order, such that information for each updated regulation is stored in a single row.

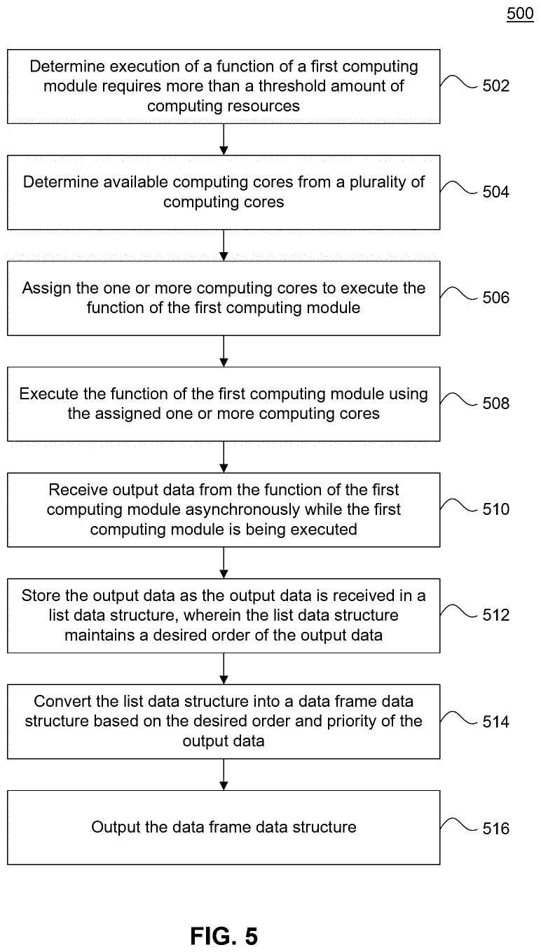

FIG. 5 is a flowchart 500 illustrating a method for executing a computing module according to an embodiment. Searching an external data source for updated compliance data different than compliance data used by a compliance application may be executed by a function (i.e., scraping engine 152 as shown in FIG. 1).

Flowchart 500 starts at operation 502. In operation 502, a deployment system may determine execution of a function of a first computing module requires more than a threshold amount of computing resources. Computing resources may include memory, CPU power, storage space, and/or the like. The function of the first computing module may be code to be executed. The deployment system may determine execution of the function is computationally expensive based on an expected amount data to be processed by the function multiplied by an expected amount of calculations to be executed by the function.

In operation 504, an execution engine may determine available computing cores. The execution engine may identify the available computing cores from a pool of computing cores. Each computing core can be a separate processing unit.

In operation 506, the execution engine may assign the one or more computing cores to execute the function of the first computing module.

In operation 508, the execution engine may execute the function of the first computing module using the assigned one or more computing cores. The assigned one or more computing cores are dedicated to executing the function of the first computing module. The execution engine may transmit a call to the assigned one or more computing cores. The call may include instructions to the assigned one or more computing cores to execute the function asynchronously. The call may further include arguments required by the function to perform the tasks of the function. The call may further include a different call to a function for converting a data frame data structure to be output by the function to a list data structure.

In operation 510, the execution engine may receive output data from the function of the first computing module asynchronously while the function of the first computing module is being executed. Each of the tasks of the function may be executed asynchronously. For example, the function may include task 1; task 2; and task 3, and task 1, task 2, and task 3 may be executed concurrently by the assigned computing cores. The assigned computing cores may execute different tasks of the function irrespective of their order within the function. The function may output data in response to completing a task irrespective of the order of the task in the function. In the event task 3 is completed before task 1, the function will output the result of task 3 before task 1.

In operation 512, the execution engine may store the output data as the output data is received in a list data structure as described with respect to operation 408. As the data is being received asynchronously, the list data structure maintains a desired order of the output data.

In operation 514, the execution engine may convert the list data structure into a data frame data structure based on the desired order and priority of the output data. The list may be a one-dimensional data structure and the data frame data structure may be a two dimensional data structure. The execution engine may transpose the output data from the list data structure to the data frame data structure. The execution engine may ensure the data is transposed from the list to the data frame in the desired order.

In operation 516, the deployment system may output the data frame data structure. The data frame data structure may be output to a user device. Alternatively, the data frame data structure may be output to a different sub-computing system within a distributed and/or cloud computing environment, for further processing.

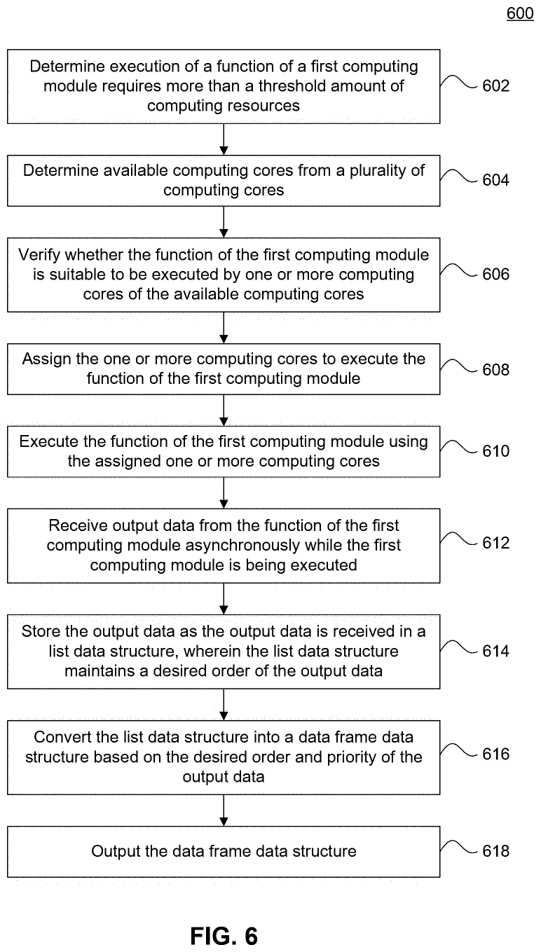

FIG. 6 is a flowchart 600 illustrating a process for verifying a computing module is suitable for multi-coring according to an embodiment.

Flowchart 600 starts at operation 602. In operation 602, a deployment system may determine execution of a function of a first computing module requires more than a threshold amount of computing resources. Computing resources may include memory, CPU power, storage space, and/or the like.

In operation 604, the deployment system may determine available computing cores.

In operation 606, the deployment system may verify whether the function of the first computing module is suitable to be executed by one or more computing cores of the available computing cores. In determining whether the function of the first computing module is suitable by the one or more computing cores of the available computing cores the deployment system determines whether the function is suitable to be executed using multi-coring. As described above, multi-coring is dedicating one or more computing cores to execute the function. The deployment system may determine a function is suitable for multi-coring based on the amount of data to be processed multiplied by the calculations to be executed by the function being below a threshold amount, the function not including any interdependent calculations, and the function not having any interdependencies with other functions.

In operation 608, in response to verifying the function of the first computing module is suitable to be executed by the one or more computing cores of the available computing cores, the deployment system may assign the one or more computing cores to execute the function of the first computing module.

In operation 610, the deployment system may execute the function of the first computing module using the assigned one or more computing cores. The assigned one or more computing cores are dedicated to executing the function of the first computing module.

In operation 612, the deployment system may receive output data from the function of the first computing module asynchronously while the first computing module is being executed.

In operation 614, the deployment system may store the output data as the output data is received in a list data structure, wherein the list data structure maintains a desired order of the output data.

In operation 616, the deployment system may convert the list data structure into a data frame data structure based on the desired order and priority of the output data.

In operation 618, the deployment system may output the data frame data structure.

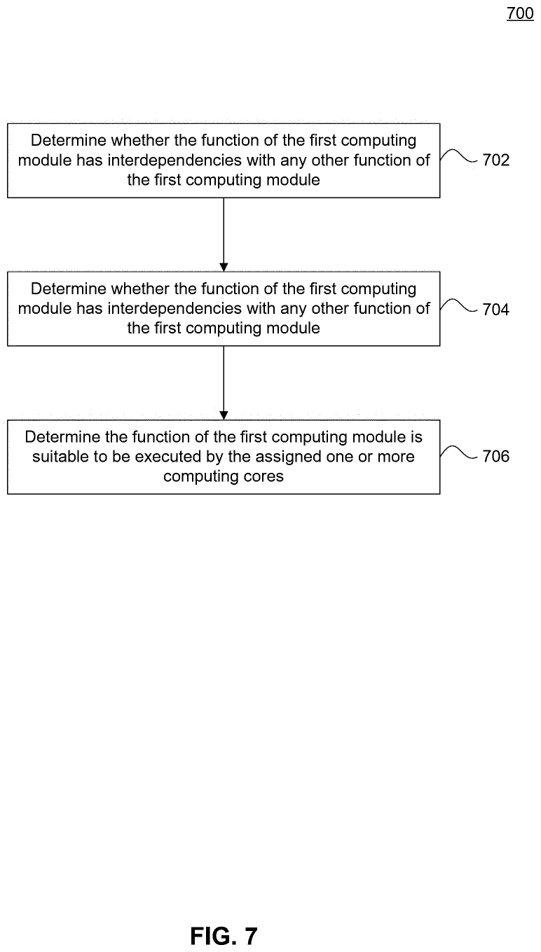

FIG. 7 is a flowchart 700 illustrating a process for verifying a computing module is suitable for multi-coring according to an embodiment.

Flowchart 700 starts with operation 702. In operation 702, a deployment system may determine whether the function of the first computing module includes interdependencies between calculations executed in the function of the first computing module. As the tasks of the function are completed asynchronously, calculations of the function are executed out of the intended order. In this regard, there cannot be interdependencies between calculations when executing the function using multi-coring, as the assigned computing cores may attempt to execute a second calculation without waiting for the result of the first calculation. If the second calculation includes a variable or value to be calculated by the first calculation, executing the second calculation before the completion of the first calculation may cause an error.

In operation 704, the deployment system may determine whether the function of the first computing module has interdependencies with any other function of the first computing module. As stated above, in multi-coring tasks of the function are executed asynchronously. Therefore, while using multi-coring the function may not rely on different function calls as the tasks are not completed in the intended order.

In operation 706, in response to determining the function of the first computing module is void of interdependencies between calculations executed in the function of the first computing module or other functions of the first computing module, the deployment system may determine that the first computing module is suitable for execution on the assigned one or more computing cores. In the event the deployment system may determine execution of more than one function requires more than the threshold amount of computing resources or the function interdependent calculations or have interdependencies with another function, the deployment system may execute the first and second functions of the second computing module, in parallel, using any one of the available computing cores.

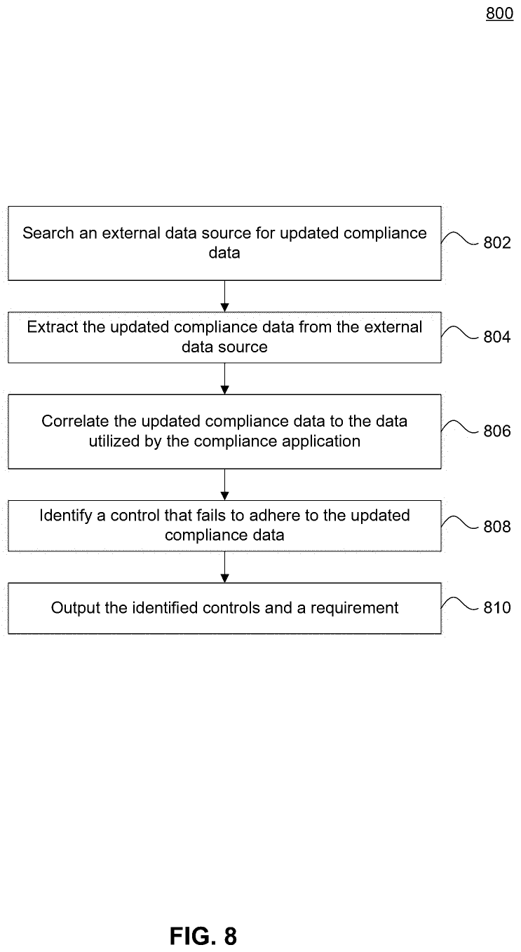

FIG. 8 is a flowchart 800 illustrating a process for identifying controls which do not align with updated compliance data according to an embodiment.

Flowchart 800 starts at operation 802. In operation 802, a scraping engine searches an external data source for updated compliance data different than compliance data currently used by a compliance application. Scraping engine may be a SCRAPY application developed in python. SCRAPY is an open-source web crawling framework written in Python. SCRAPY is built using self-contained crawlers that may be given a set of instructions. External data sources may include websites, databases, data repositories, RSS feeds, web services, and/or the like.

In operation 804, the scraping engine extracts the updated compliance data from the external data source. The scraping engine may extract the alphanumeric string of the updated compliance data from the external data source.

In operation 806, an analyze engine correlates the updated compliance data to the data utilized by the compliance application stored in a database. The analyze engine may correlate the updated compliance data with the compliance data by matching a regulation ID number of the updated compliance data with a regulation ID of the compliance data.

In operation 808, the analyze engine identifies a control that fails to adhere to the updated compliance data based on a difference between the updated compliance data and the compliance data currently used by the compliance application. The control may control the operation of the compliance application based on the compliance data.

In operation 810, the analyze engine outputs the identified controls and a requirement to align the identified control with the updated compliance data. The analyze engine may store the requirement in the database.

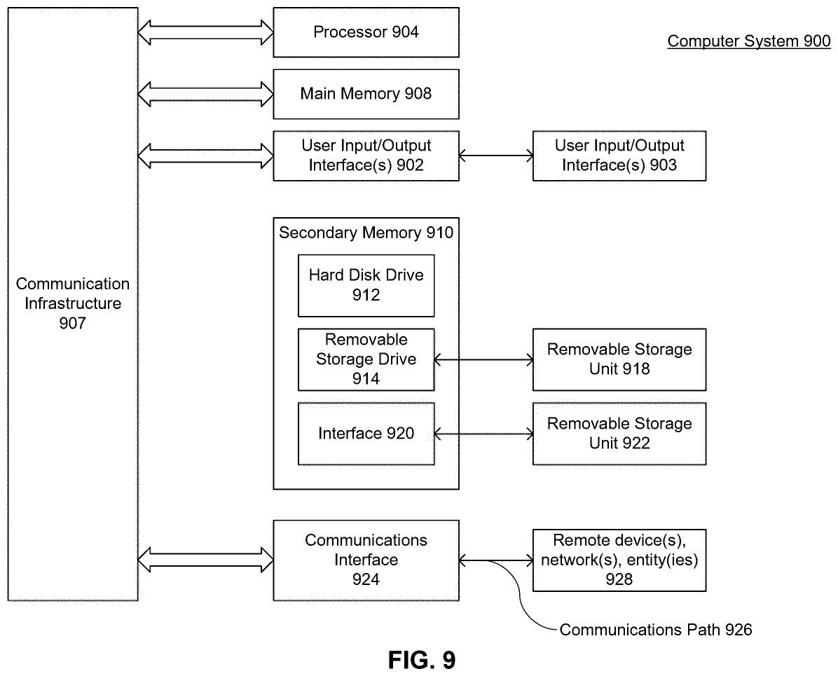

FIG. 9 is a block diagram of example components of computer system 900. One or more computer systems 900 may be used, for example, to implement any of the embodiments discussed herein, as well as combinations and sub-combinations thereof. Computer system 900 may include one or more processors (also called central processing units, or CPUs), such as a processor 904. Processor 904 may be connected to a communication infrastructure or bus 907.

Computer system 900 may also include user input/output interface(s) 902, such as monitors, keyboards, pointing devices, etc., which may communicate with communication infrastructure 907 through user input/output interface(s) 902.

One or more of processors 904 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 900 may also include a main or primary memory 908, such as random access memory (RAM). Main memory 908 may include one or more levels of cache. Main memory 908 may have stored therein control logic (i.e., computer software) and/or data.

Computer system 900 may also include one or more secondary storage devices or memory 910. Secondary memory 910 may include, for example, a hard disk drive 912 and/or a removable storage drive 914.

Removable storage drive 914 may interact with a removable storage unit 918. Removable storage unit 918 may include a computer usable or readable storage device having stored thereon computer software (control logic) and/or data. Removable storage unit 918 may be a program cartridge and cartridge interface (such as that found in video game devices), a removable memory chip (such as an EPROM or PROM) and associated socket, a memory stick and USB port, a memory card and associated memory card slot, and/or any other removable storage unit and associated interface. Removable storage drive 914 may read from and/or write to removable storage unit 918.

Secondary memory 910 may include other means, devices, components, instrumentalities or other approaches for allowing computer programs and/or other instructions and/or data to be accessed by computer system 900. Such means, devices, components, instrumentalities or other approaches may include, for example, a removable storage unit 922 and an interface 920. Examples of the removable storage unit 922 and the interface 920 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 900 may further include a communication or network interface 924. Communication interface 924 may enable computer system 900 to communicate and interact with any combination of external devices, external networks, external entities, etc. (individually and collectively referenced by reference number 928). For example, communication interface 924 may allow computer system 900 to communicate with external or remote devices 928 over communications path 926, which may be wired and/or wireless (or a combination thereof), and which may include any combination of LANs, WANs, the Internet, etc. Control logic and/or data may be transmitted to and from computer system 900 via communication path 926.

Computer system 900 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 900 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 900 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 900, main memory 908, secondary memory 910, and removable storage units 918 and 922, as well as tangible articles of manufacture embodying any combination of the foregoing. Such control logic, when executed by one or more data processing devices (such as computer system 900), may cause such data processing devices to operate as described herein.

It is to be appreciated that the Detailed Description section, and not the Summary and Abstract sections, is intended to be used to interpret the claims. The Summary and Abstract sections may set forth one or more but not all exemplary embodiments of the present disclosure as contemplated by the inventor(s), and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

What is claimed is:

1. A computer-implemented method comprising:
executing, by one or more computing devices, a function configured to analyze data using one or more computing cores dedicated to executing the function, wherein execution of the function requires more than a threshold amount of computing resources based on an amount of the data;
transposing, by the one or more computing devices, output data in a first instance of a data frame data structure received from the function into a list data structure as the output data is received by the first instance of the data frame data structure, wherein the list data structure is a one-dimensional data structure and the output data is positioned in the list data structure based on a key-value pair and desired order of the output data, wherein the first instance of the data frame structure is a two-dimensional data structure and stores the output data in an incorrect order; and
outputting, by the one or more computing devices, the list data structure as a second instance of a data frame data structure based on the key-value pair and desired order of the output data, wherein the second instance of the data frame data structure stores the output data in the desired order.

2. The computer-implemented method of claim 1, further comprising:
detecting, by the one or more computing devices, using the function, words in the data based on a predefined list of words; and
generating, by the one or more computing devices, using the function, a report regarding the detected words in the data.

3. The computer-implemented method of claim 1, further comprising receiving, by the one or more computing devices, the data from disparate sources via email, short messaging service (SMS), phone call, or voice message, wherein the data is audio or text data.

4. The computer-implemented method of claim 1, further comprising:
verifying, by the one or more computing devices, whether the function is suitable to be executed by the one or more computing cores dedicated to executing the function by:
determining, by the one or more computing devices, an amount of calculations executed by the function requires more than the threshold amount of computing resources.

5. The computer-implemented method of claim 1, further comprising:
verifying, by the one or more computing devices, whether the function is suitable to be executed by the one or more computing cores dedicated to executing the function by:
determining, by the one or more computing devices, the function is void of interdependencies between calculations executed in the function.

6. The computer-implemented method of claim 1, further comprising:
verifying, by the one or more computing devices, whether the function is suitable to be executed by the one or more computing cores dedicated to executing the function by:
determining, by the one or more computing devices, the function of the first computing module is void of interdependencies between the other functions.

7. The computer-implemented method of claim 1, further comprising determining, by the one or more computing devices, that the one or more computing cores dedicated to executing the function are available to execute the function.

8. A system comprising:
a memory;
a processor coupled to the memory, the processor configured to:
execute a function configured to analyze data using one or more computing cores dedicated to executing the function, wherein execution of the function requires more than a threshold amount of computing resources based on an amount of the data;
transpose output data in a first instance of a data frame data structure received from the function into a list data structure as the output data is received by the first instance of the data frame data structure, wherein the list data structure is a one-dimensional data structure and the output data is positioned in the list data structure based on a key-value pair and desired order of the output data, wherein the first instance of the data frame structure is a two-dimensional data structure and stores the output data in an incorrect order; and
output the list data structure as a second instance of a data frame data structure based on the key-value pair and desired order of the output data, wherein the second instance of the data frame data structure stores the output data in the desired order.

9. The system of claim 8, the processor further configured to:
detect, using the function, words in the data based on a predefined list of words; and
generate, using the function, using the function, a report regarding the detected words in the data.

10. The system of claim 8, the processor further configured to receive the data from disparate sources via email, short messaging service (SMS), phone call, or voice message, wherein the data is audio or text data.

11. The system of claim 8, the processor further configured to:
verify whether the function is suitable to be executed by the one or more computing cores dedicated to executing the function by:
determining an amount of calculations executed by the function requires more than the threshold amount of computing resources.

12. The system of claim 8, the processor further configured to:
verify whether the function is suitable to be executed by the one or more computing cores dedicated to executing the function by:
determining the function is void of interdependencies between calculations executed in the function.

13. The system of claim 8, the processor further configured to:
verify whether the function is suitable to be executed by the one or more computing cores dedicated to executing the function by:
determining the function of the first computing module is void of interdependencies between the other functions.

14. The system of claim 8, the processor further configured to determine that the one or more computing cores dedicated to executing the function are available to execute the function.

15. A non-transitory computer-readable medium having instructions stored thereon, execution of which, by one or more processors of a device, cause the one or more processors to perform operations comprising:
executing a function configured to analyze data using one or more computing cores dedicated to executing the function, wherein execution of the function requires more than a threshold amount of computing resources based on an amount of the data;
transposing output data in a first instance of a data frame data structure received from the function into a list data structure as the output data is received by the first instance of the data frame data structure, wherein the list data structure is a one-dimensional data structure and the output data is positioned in the list data structure based on a key-value pair and desired order of the output data, wherein the first instance of the data frame structure is a two-dimensional data structure and stores the output data in an incorrect order; and
outputting the list data structure as a second instance of a data frame data structure based on the key-value pair and desired order of the output data, wherein the second instance of the data frame data structure stores the output data in the desired order.

16. The non-transitory computer-readable medium of claim 15, the operations further comprising:
detecting, using the function, words in the data based on a predefined list of words; and
generating, using the function, a report regarding the detected words in the data.

17. The non-transitory computer-readable medium of claim 15, the operations further comprising receiving the data from disparate sources via email, short messaging service (SMS), phone call, or voice message, wherein the data is audio or text data.

18. The non-transitory computer-readable medium of claim 15, the operations further comprising:
verifying whether the function is suitable to be executed by the one or more computing cores dedicated to executing the function by:
determining an amount of calculations executed by the function requires more than the threshold amount of computing resources.

19. The non-transitory computer-readable medium of claim 15, the operations further comprising:
verifying whether the function is suitable to be executed by the one or more computing cores dedicated to executing the function by:
determining the function is void of interdependencies between calculations executed in the function.

20. The non-transitory computer-readable medium of claim 15, the operations further comprising:
verifying whether the function is suitable to be executed by the one or more computing cores dedicated to executing the function by:
determining the function of the first computing module is void of interdependencies between the other functions.
